(19) United States
(12) Patent Application Publication
(10) Pub. No.: US 2026/0087956 A1
(43) Pub. Date: Mar. 26, 2026

(54) DISPLAY DRIVING DEVICE OF PIXEL ARRAY HAVING A PLURALITY OF PIXEL DRIVING CIRCUITS

(71) Applicant: RAONTECH, Inc., Seongnam-si (KR)

(72) Inventor: Minsu JEONG, Seongnam-si (KR)

(73) Assignee: RAONTECH, Inc., Seongnam-si (KR)

(21) Appl. No.: 19/341,530

(22) Filed: Sep. 26, 2025

(30) Foreign Application Priority Data
Sep. 26, 2024 (KR) 10-2024-0130692

(51) Int. Cl. G09G 3/20

(52) U.S. Cl. CPC G09G 3/20; G09G 2300/0465; G09G 2330/021; G09G 2340/0407

(57) ABSTRACT

A display driving device of a pixel array having a plurality of gate lines and a plurality of data lines, and a plurality of pixel driving circuits respectively connected to the plurality of gate lines and the plurality of data lines, the device including: a data driver configured to output pixel data to the plurality of data lines; a data selection circuit configured to process the outputted pixel data and transmit the processed pixel data to the plurality of pixel driving circuits; a gate driver configured to output gate information to the plurality of gate lines; and a gate selection circuit configured to process the outputted gate information and control a timing at which the pixel data is stored in the plurality of pixel driving circuits, the data selection circuit and the gate selection circuit are configured to store the processed pixel data in the plurality of pixel driving circuits.

### CROSS-REFERENCE TO RELATED APPLICATION

This U.S. Non-Provisional Patent Application claims the benefit under 35 U.S.C. § 119 of Korean Patent Application 10-2024-0130692, filed September 26, 2024, which is hereby incorporated by reference in its entirety.

### TECHNICAL FIELD

The present invention relates to a display driving device of a pixel array having a plurality of pixel driving circuits.

### BACKGROUND

In general, a display device is a device that displays an image on a display panel using electrical and optical characteristics, and includes a liquid crystal display (LCD) and an organic light emitting diode (OLED) display. These display devices have a structure in which a number of pixels are arranged in a two-dimensional matrix of rows and columns.

FIG. 1 is a drawing for explaining a pixel driving method of a conventional display device.

Referring to FIG. 1, in order to implement a resolution of CХR, a display device generally stores desired data in a pixel circuit by crossing a column line and a row line, and drives pixels through the pixel circuit.

In order to implement the resolution of CХR, a display device needs to include C column drive lines and drive circuits, R row drive lines and drive circuits, and CХR pixel circuits.

Here, in order to increase the resolution, the values corresponding to C and R are required to increase by the desired resolution. In other words, when the complexity of the pixel drive line and drive circuit increases, and the size of the driven pixel is constant, there was a problem in that the size of the display device increases by the amount of the increase in resolution.

### BRIEF SUMMARY

The present invention provides an ultra-high-resolution micro-display by reducing a video driving resolution of a display driver required for pixel driving.

The present invention also provides a display driving device having improved power consumption by reducing a resolution of a display driving circuit.

The present invention also provides a display driving device that improves a limitation in a conventional driving system, which requires a small-sized pixel driving circuit and high power consumption to achieve a desired resolution.

### BRIEF DESCRIPTION OF DRAWINGS

FIG. 1 is a diagram for explaining a pixel driving method of a conventional display device.

FIG. 2a is a diagram illustrating a display driver driving circuit that drives multiple resolutions according to the present invention.

FIG. 2b is a diagram illustrating a configuration of a pixel driving circuit according to the present invention.

FIG. 3a is a diagram illustrating an embodiment of a method for storing data in multiple rows or columns simultaneously according to the present invention.

FIG. 3b is a diagram illustrating another embodiment of a method for storing data in multiple rows or columns simultaneously according to the present invention.

FIG. 4 is a diagram illustrating an example of a method for reducing the number of EN signals by blocking EN signals according to the present invention and a screen configuration through section-by-section addressing.

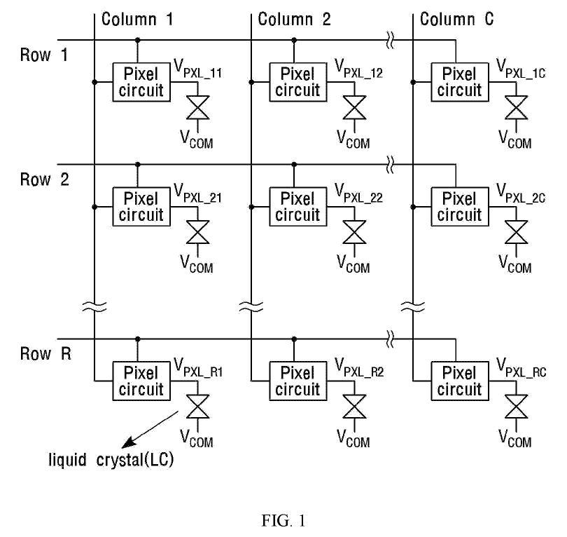

### DETAILED DESCRIPTION

### Technical Solution

An embodiment of the present invention provides a display driving device of a pixel array having a plurality of gate lines and a plurality of data lines, and a plurality of pixel driving circuits respectively connected to the plurality of gate lines and the plurality of data lines, the display driving device including: a data driver configured to output pixel data to the plurality of data lines; a data selection circuit configured to process the outputted pixel data and transmit the processed pixel data to the plurality of pixel driving circuits; a gate driver configured to output gate information to the plurality of gate lines; and a gate selection circuit configured to process the outputted gate information and control a timing at which the pixel data is stored in the plurality of pixel driving circuits, in which the data selection circuit and the gate selection circuit are configured to select some of the plurality of pixel driving circuits and to simultaneously store the processed pixel data in the selected pixel driving circuit.

In an embodiment, the data selection circuit and the gate selection circuit may be configured to reduce the number of driven pixels to 1/N so as to simultaneously drive a pixel array having N pixel driving circuits among the pixel arrays having the plurality of pixel driving circuits.

In an embodiment, the gate selection circuit may be configured to receive the gate information in a number less than the number of rows of the pixel array from the gate driver and process the gate information into a gate driving signal having the number of rows.

In an embodiment, the pixel driving circuit may be configured to store the pixel data by the pixel driving signal, the gate driving signal, and an enable (EN) signal, and

the pixel driving circuit may be configured to store the pixel data in the pixel driving circuit when the EN signal is 'ON'.

In an embodiment, the output of the data driver may be less than the output of the pixel array.

In an embodiment of the present invention, a display driving device for driving multiple resolutions by an EN signal received from an external EN signal generating unit of a pixel array having a plurality of gate lines and a plurality of data lines, and a plurality of pixel driving circuits respectively connected to the plurality of gate lines and the plurality of data lines includes: a data driver configured to output pixel data to the plurality of data lines; a data selection circuit configured to process the outputted pixel data and transmit the processed pixel data to the plurality of pixel driving circuits; an EN signal receiving unit configured to receive an EN signal from an external terminal, the EN signal controlling the storage of the pixel data of the pixel driving circuit; a gate driver configured to output gate information to the plurality of gate lines; and a gate selection circuit configured to process the outputted gate information and control a point in time at which the pixel data is stored in the plurality of pixel driving circuits based on the received EN signals, in which the data selection circuit and the gate selection circuit are configured to simultaneously and selectively store the processed pixel data in the plurality of pixel driving circuits based on control of the received EN signals.

In an embodiment, the pixel driving circuit may be configured to store the pixel data in the pixel driving circuit when the received EN signal is 'ON', and not to store the pixel data in the pixel driving circuit when the received EN signal is 'OFF'.

In an embodiment, the EN signal generating unit may be configured to divide an area of the pixel array to generate an EN signal of 'ON' in the driving pixel array and an EN signal of 'OFF' in the non-driving pixel array.

In an embodiment, the data selection circuit and the gate selection circuit may be configured to reduce the number of driven pixels to 1/N so as to simultaneously drive a pixel array having N pixel driving circuits among the pixel arrays having the plurality of pixel driving circuits.

In an embodiment, the output of the data driver may be less than that of the pixel array.

In an embodiment of the present invention, a display driving device for driving multiple resolutions by an EN signal received from an external EN signal generating unit of a pixel array having a plurality of gate lines and a plurality of data lines, and a plurality of pixel driving circuits respectively connected to the plurality of gate lines and the plurality of data lines includes: a data driver configured to output pixel data to the plurality of data lines; a data selection circuit configured to process the outputted pixel data and transmit the processed pixel data to the plurality of pixel driving circuits; an EN signal receiving unit configured to receive an EN signal from an external terminal, the EN signal controlling the storage of the pixel data of the pixel driving circuit; a gate driver configured to output gate information to the plurality of gate lines; and a gate selection circuit configured to process the outputted gate information and control a point in time at which the pixel data is stored in the plurality of pixel driving circuits based on the received EN signals, in which the data selection circuit and the gate selection circuit are configured to simultaneously and selectively store the processed pixel data in the plurality of pixel driving circuits based on control of the received EN signals.

In an embodiment, the pixel driving circuit may be configured to store the pixel data in the pixel driving circuit when the received EN signal is 'ON', and not to store the pixel data in the pixel driving circuit when the received EN signal is 'OFF'.

In an embodiment, the display driving device may further include an EN signal control unit, in which the EN signal control unit is configured to divide an area of the pixel array, classify the divided area as a driving pixel array when the EN signal receiving unit receives an EN signal of 'ON', and classify the divided area as a non-driving pixel array when the EN signal receiving unit receives an EN signal of 'OFF'.

In an embodiment, the data selection circuit and the gate selection circuit may be configured to reduce the number of driven pixels to 1/N so as to simultaneously drive a pixel array having N pixel driving circuits among the pixel arrays having the plurality of pixel driving circuits.

In an embodiment, the output of the data driver may be less than that of the pixel array.

In an embodiment of the present invention, a display driving device for driving a pixel array having a plurality of pixel driving circuits based on the output of pixel data and gate information of a data driver and a gate driver includes: a pixel array having N pixel driving circuits among the pixel arrays having the plurality of pixel driving circuits; and a data selection circuit and a gate selection circuit configured to reduce the number of driven pixels to 1/N so as to simultaneously drive the pixel array having the N pixel driving circuits, in which the data selection circuit and the gate selection circuit are configured to process the output pixel data and gate information and to simultaneously and selectively store the processed pixel data in the pixel driving circuit with the number of driving pixels reduced to 1/N, and are configured to store the pixel data only in gate lines and data lines selected at specific intervals among the plurality of gate lines and the plurality of data lines.

### Advantageous Effects

The present invention has the effect of reducing the size of the pixel circuit by reducing the resolution of the driving system required for pixel driving, thereby implementing the ultra-high-resolution micro display.

The present invention has the effect of improving power consumption by reducing the resolution of the pixel driving circuit.

The present invention has the effect of simplifying the manufacturing process and improving the performance of the display device by reducing the number of transmission lines or transmission rate between unit components by reducing the transmission video data of the display device.

The present invention has the effect of reducing connection lines by minimizing the drive lines of the display driver device by enabling the display device to support multiple resolutions according to the line of sight of the XR device.

### Mode for Invention

Specific details of the embodiments are included in the detailed description and drawings.

The advantages and features of the present invention, and the methods for achieving them, will become clearer with reference to the embodiments described in detail below with the accompanying drawings. However, the present invention is not limited to the embodiments disclosed below and may be implemented in various different forms. These embodiments are provided solely to ensure that the disclosure of the present invention is complete and to fully inform those skilled in the art of the scope of the invention, and the present invention is defined solely by the scope of the claims. Like reference numerals designate like elements throughout the specification.

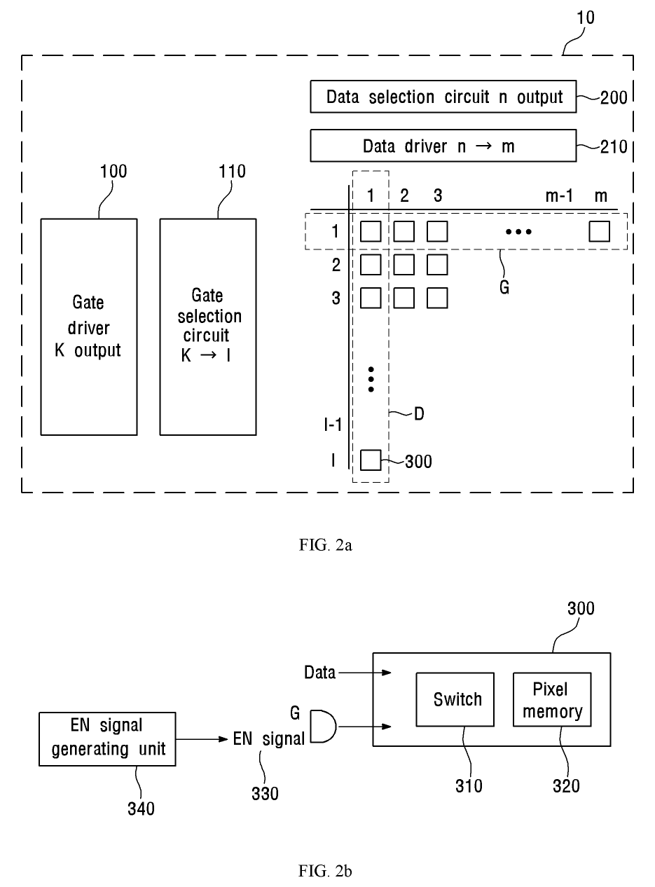

FIG. 2a

FIG. 2a is a diagram illustrating a display driver driving circuit that drives multiple resolutions according to the present invention. FIG. 2b is a diagram illustrating a configuration of a pixel driving circuit according to the present invention.

As illustrated, a display driving device 10 according to the present invention may include a gate driver 100, a gate selection circuit 110, a data driver 210, a data selection circuit 210, and each pixel driving circuit 300. Specifically, the gate driver 100 may select k rows with k outputs, but the gate selection circuit 110 may drive l rows by amplifying the number of outputs. In this case, l may be greater than or equal to k, and thus the display driving circuit 10 may select more rows. In addition, the data driver 210 may select n columns with n outputs, but the data selection circuit 210 may amplify the number of outputs to drive m columns. In this case, m may be greater than or equal to n, and thus the display driving circuit 10 may select more columns.

According to an embodiment of the present invention, the display driving device 10 may be driven by storing pixel information in the pixel memory 320 of some pixel driving circuits 300 rather than storing data in a one-to-one active matrix manner in the pixel driving circuits 300 for each gate line G and data line D. For a specific example, since the gate selection circuit 110 amplifies k outputs into l rows, the gate selection circuit 110 may select only some of l rows to store data. That is, the data selection circuit 210 may operate in a manner such that it drives only a specific column and does not drive the remaining columns. In addition, since the data selection circuit 210 amplifies n outputs into m columns, he data selection circuit 210 may select only some of l columns to store data. That is, the data selection circuit 210 may be operated in a manner that drives only a specific column and does not drive the remaining columns.

### Pixel driving circuit + EN signal

According to the present invention, the pixel driving circuit 300 may include a switch 310 and a pixel memory 320. Specifically, the switch 310 may control a signal in the pixel driving circuit 300 and supply a voltage to a selected pixel. That is, when a specific pixel driving circuit 300 is selected according to a row signal selected from the gate selection circuit 110 and a column signal selected from the data selection circuit 210, a voltage may be applied to the selected pixel driving circuit 300 to drive the pixel driving circuit 300. In addition, the switch 310 may control the driving signal to be transmitted only to a desired pixel driving circuit 300 for a specific period of time and the remaining pixel driving circuits 300 not to be driven, thereby allowing a desired image to be accurately displayed.

According to the present invention, the pixel driving circuit 300 may include a pixel memory 320. Specifically, the pixel memory 320 may store a voltage value transmitted from the data selection circuit 210 and may be configured as a capacitor. That is, when the switch 310 is turned on, the signal transmitted from the data selection circuit 210 is transmitted to the pixel driving circuit 300, and even after the switch 310 is turned off, the pixel memory 320 may store and maintain the corresponding data for a certain period of time.

According to the present invention, the EN signal generating unit 340 may be disposed outside the display driving device 10 or may be disposed inside the display driving device 10. Specifically, when the EN signal generating unit 340 is disposed outside the display driving device 10, the display driving device 10 according to the present invention may further include an EN signal reception unit (not shown) that receives an EN signal 330 that controls pixel data storage of the pixel driving circuit 300 from an external terminal.

According to the present invention, the pixel driving circuit 300 may be configured to store pixel data by a pixel driving signal, a gate driving signal, and an EN (Enable) signal 330. Specifically, the pixel driving circuit 300 may be configured to store pixel data in the pixel driving circuit 300 when the EN (Enable) signal 330 is 'ON'.

According to the present invention, the output of the data driver 210 of the pixel driving circuit 300 may be configured to be less than the output of the pixel array.

According to the present invention, the display driving device 10 may include a plurality of pixel driving circuits 300 respectively connected to a plurality of gate lines G and a plurality of data lines D. Specifically, the display driving device 10 may include a data driver 210 for outputting pixel data to a plurality of data lines D, a data selection circuit 210 for processing the output pixel data and transmitting the processed pixel data to a plurality of pixel driving circuits 300, a gate driver 100 for outputting gate information to a plurality of gate lines G, and a gate selection circuit 110 for processing the output gate information and controlling a point in time at which the pixel data is stored in the plurality of pixel driving circuits 300. In this case, the data selection circuit 210 and the gate selection circuit 110 may be configured to simultaneously and selectively store the processed pixel data in the plurality of pixel driving circuits 300.

According to the present invention, the gate selection circuit 110 of the display driving device 10 may be configured to receive gate information of a number less than the number of rows of the pixel array from the gate driver 100 and process the gate information into a gate driving signal having the number of rows.

According to an embodiment of the present invention, the display driving device 10 may drive multiple resolutions by an EN signal 330 of a pixel array having a plurality of pixel driving circuits 300 respectively connected to a plurality of gate lines G and a plurality of data lines D.

According to an embodiment of the present invention, the display driving device 10 may include a data driver 210 for outputting pixel data to a plurality of data lines D, a data selection circuit 200 for processing the output pixel data and transmitting the processed pixel data to a plurality of pixel driving circuits 300, an EN signal generating unit 340 for generating an EN signal 330 for controlling pixel data storage of the pixel driving circuit 300, a gate driver 100 for outputting gate information to a plurality of gate lines G, and a gate selection circuit 110 for controlling a point in time at which pixel data is stored in the plurality of pixel driving circuits 300 based on the EN signal 330 generated by processing the output gate information.

According to an embodiment of the present invention, the data selection circuit 200 and the gate selection circuit 110 may be configured to simultaneously and selectively store processed pixel data in a plurality of pixel driving circuits 300 based on the control of the generated EN signal 330.

According to an embodiment of the present invention, the pixel driving circuit 300 may be configured such that pixel data is stored in the pixel driving circuit 300 when the EN (Enable) signal 330 is 'ON'. In addition, the pixel driving circuit 300 may be configured such that pixel data is not stored in the pixel driving circuit 300 when the EN (Enable) signal 330 is 'OFF'.

According to an embodiment of the present invention, the EN signal generating unit 340 may divide the area of the pixel array to generate an EN signal 330 of 'ON' in the driving pixel array and generate an EN signal 330 of 'OFF' in the non-driving pixel array.

According to an embodiment of the present invention, the data selection circuit 200 and the gate selection circuit 110 may be configured to reduce the number of driven pixels to 1/N so as to simultaneously drive a pixel array having N pixel driving circuits 300 among a pixel array having a plurality of pixel driving circuits 300.

According to an embodiment of the present invention, the output of the data driver 210 may be configured to be less than the output of the pixel array.

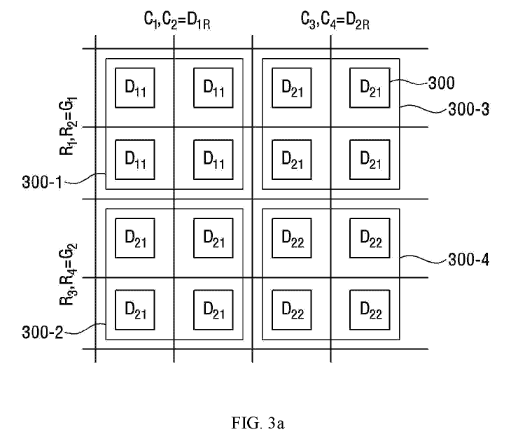

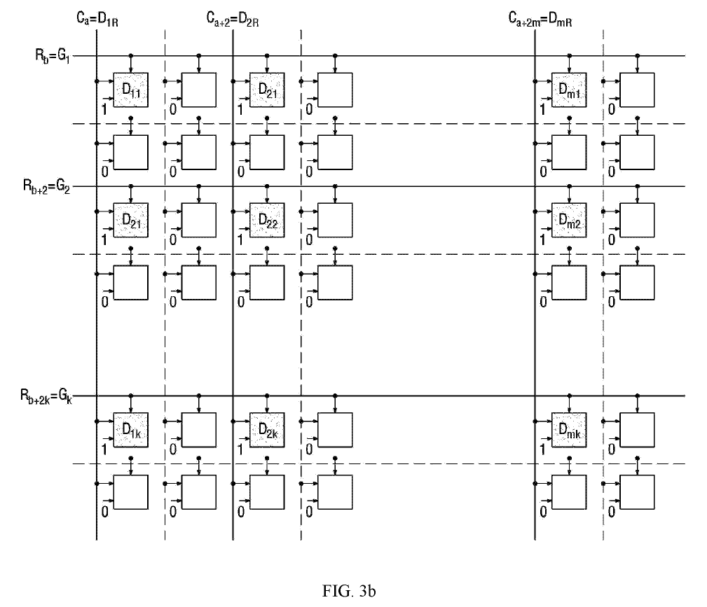

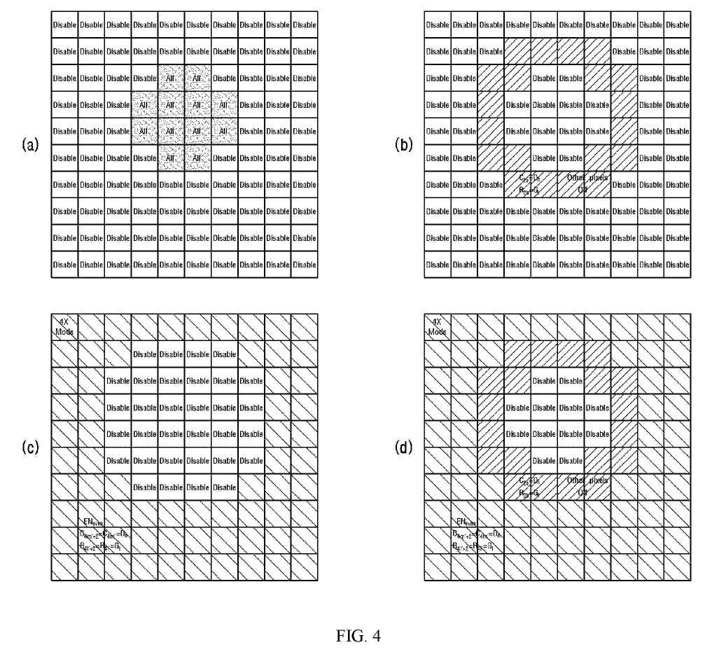

FIG. 3a

FIG. 3a is a diagram illustrating an embodiment of a method for storing data in multiple rows or columns simultaneously according to the present invention.

According to an embodiment of the present invention, the output gate information may mean a control signal of a gate line G output by a gate driver 100.

According to an embodiment of the present invention, the data selection circuit 210 and the gate selection circuit 110 may be configured to reduce the number of driven pixels to 1/N so as to simultaneously drive a pixel array having N pixel driving circuits 300 among a pixel array having a plurality of pixel driving circuits 300. For a specific example, as shown in FIG. 3a, the data selection circuit 210 may output the same pixel data so that the first and second columns have the same pixel data. In addition, the gate selection circuit 110 may output the same gate information so that the first and second rows have the same gate information. In this case, data may be stored so that the pixel arrays 300-1 of (1,1), (1,2), (2,1), and (2,2) have the same data. In this case, the data selection circuit 210 and the gate selection circuit 110 may be configured to reduce the number of driven pixels to 1/4 so as to simultaneously drive a pixel array having four pixel driving circuits 300 among a pixel array having a plurality of pixel driving circuits 300.

FIG. 3b is a diagram illustrating another embodiment of a method for storing data in multiple rows or columns simultaneously according to the present invention.

As illustrated, the display driving device 10 may be driven in a manner of storing data in a row or column of a pixel array at regular intervals. For a specific example, the data selection circuit 210 may be driven to drive only odd-numbered inputs in the pixel array data input, and the gate selection signal 110 may be driven to have only odd-numbered row signals in the pixel array row input. At this time, the EN (Enable) signal 330 may be turned 'OFF' for pixels that are not driven, and the EN (Enable) signal 330 may be applied 'ON' only to the target pixel driving circuit 300 to store data. That is, the number of driven pixels may be reduced to improve power consumption and at the same time, the performance of the display device may be improved.

FIG. 4

FIG. 4 is a diagram illustrating an example of a method for reducing the number of EN signals by blocking EN signals and a screen configuration through section-by-section addressing according to the present invention.

According to the present invention, the gate selection circuit 110 of the display driving device 10 may be configured to receive gate information of a number less than the number of rows of the pixel array from the gate driver 100 and process the gate information into a gate driving signal having the number of rows.

According to an embodiment of the present invention, a display driving device 10 may drive multiple resolutions by an EN signal 330 of a pixel array having a plurality of pixel driving circuits 300 each connected to a plurality of gate lines G and a plurality of data lines D.

According to an embodiment of the present invention, the display driving device 10 may include a data driver 210 for outputting pixel data to a plurality of data lines D, a data selection circuit 200 for processing the output pixel data and transmitting the processed pixel data to a plurality of pixel driving circuits 300, an EN signal generating unit 340 for generating an EN signal 330 for controlling pixel data storage of the pixel driving circuit 300, a gate driver 100 for outputting gate information to a plurality of gate lines G, and a gate selection circuit 110 for controlling a point in time at which pixel data is stored in the plurality of pixel driving circuits 300 based on the EN signal 330 generated by processing the output gate information.

According to an embodiment of the present invention, the data selection circuit 200 and the gate selection circuit 110 may be configured to simultaneously and selectively store processed pixel data in a plurality of pixel driving circuits 300 based on the control of the generated EN signal 330.

According to an embodiment of the present invention, the display driving device 10 may include a data selection circuit 200 and a gate selection circuit 110 configured to reduce the number of driven pixels to 1/N so as to simultaneously drive a pixel array having N pixel driving circuits 300 and a pixel array having N pixel driving circuits 300 among a pixel array having a plurality of pixel driving circuits 300. Specifically, the data selection circuit 200 and the gate selection circuit 110 may be configured to process output pixel data and gate information and selectively store the processed pixel data in the pixel driving circuit 300 at the same time with the number of driven pixels reduced to 1/N. In addition, the data selection circuit 200 and the gate selection circuit 110 may be configured to store pixel data only in gate lines G and data lines D selected at specific intervals among a plurality of gate lines G and a plurality of data lines D.

As illustrated, (a) of FIG. 4 illustrates an embodiment in which video data input to all pixels of a pixel array is stored in a portion of the entire screen. (b) of FIG. 4 illustrates an embodiment in which only pixels (2a, 2b) are driven and stored in the hatched area outside the area of (a) of FIG. 4. (c) of FIG. 4 illustrates an embodiment in which pixels (4a, 4b), (4a+2, 4b), (4a, 4b+2), and (4a+2, 4b+2) are driven and stored to have the same value in the area excluding the areas of (a) and (b) of FIG. 4. Finally, each of the areas of (a), (b), and (c) of FIG. 4 is driven within one frame by adjusting the time difference, so that a final screen having different resolutions for each area may be generated, as in FIG. 4 (d).

The scope of the present invention is not limited to the embodiments described above, but may be implemented in various forms within the scope of the appended claims. It is contemplated that the scope of the claims encompasses various modifications that may be made by anyone skilled in the art without departing from the spirit of the invention as claimed.

### Description of Reference Numerals

G: Gate line

D: Data line

10: Display driving device

100: Gate driver

110: Gate selection circuit

200: Data driver

210: Data selection circuit

300: Pixel driving circuit

310: Switch

320: Pixel memory

330: EN signal

1. A display driving device of a pixel array having a plurality of gate lines and a plurality of data lines, and a plurality of pixel driving circuits respectively connected to the plurality of gate lines and the plurality of data lines, the display driving device comprising:
a data driver configured to output pixel data to the plurality of data lines;
a data selection circuit configured to process the outputted pixel data and transmit the processed pixel data to the plurality of pixel driving circuits;
a gate driver configured to output gate information to the plurality of gate lines; and
a gate selection circuit configured to process the outputted gate information and control a timing at which the pixel data is stored in the plurality of pixel driving circuits,
wherein the data selection circuit and the gate selection circuit are configured to select some of the plurality of pixel driving circuits and to simultaneously store the processed pixel data in the selected pixel driving circuit.

2. The display driving device according to claim 1, wherein the data selection circuit and the gate selection circuit are configured to reduce the number of driven pixels to 1/N so as to simultaneously drive a pixel array having N pixel driving circuits among the pixel arrays having the plurality of pixel driving circuits.

3. The display driving device according to claim 1, wherein the gate selection circuit is configured to receive the gate information in a number less than the number of rows of the pixel array from the gate driver and process the gate information into a gate driving signal having the number of rows.

4. The display driving device according to claim 1, wherein the output of the data driver is less than that of the pixel array.

5. A display driving device for driving multiple resolutions by an EN signal of a pixel array having a plurality of gate lines and a plurality of data lines, and a plurality of pixel driving circuits respectively connected to the plurality of gate lines and the plurality of data lines, the display driving device comprising:
a data driver configured to output pixel data to the plurality of data lines;
a data selection circuit configured to process the outputted pixel data and transmitting the processed pixel data to the plurality of pixel driving circuits;
an EN signal generating unit configured to generate an EN signal for controlling storage of the pixel data in the pixel driving circuits;
a gate driver configured to output gate information to the plurality of gate lines; and
a gate selection circuit configured to process the outputted gate information and control a time point at which the pixel data is stored in the plurality of pixel driving circuits based on the generated EN signals,
wherein the data selection circuit and the gate selection circuit are configured to simultaneously and selectively store the processed pixel data in the plurality of pixel driving circuits based on control of the generated EN signals.

6. The display driving device according to claim 5, wherein the pixel driving circuit is configured to store the pixel data in the pixel driving circuit when the generated EN signal is 'ON', and not to store the pixel data in the pixel driving circuit when the generated EN signal is 'OFF'.

7. The display driving device according to claim 5, wherein the EN signal generating unit is configured to divide an area of the pixel array to generate an EN signal of 'ON' in the driving pixel array and an EN signal of 'OFF' in the non-driving pixel array.

8. The display driving device according to claim 5, wherein the data selection circuit and the gate selection circuit are configured to reduce the number of driven pixels to 1/N so as to simultaneously drive a pixel array having N pixel driving circuits among the pixel arrays having the plurality of pixel driving circuits.

9. The display driving device according to claim 5, wherein the output of the data driver is less than that of the pixel array.

10. A display driving device for driving multiple resolutions by an EN signal received from an external EN signal generating unit of a pixel array having a plurality of gate lines and a plurality of data lines, and a plurality of pixel driving circuits respectively connected to the plurality of gate lines and the plurality of data lines, the display driving device comprising:
a data driver configured to output pixel data to the plurality of data lines;
a data selection circuit configured to process the outputted pixel data and transmit the processed pixel data to the plurality of pixel driving circuits;
an EN signal receiving unit configured to receive an EN signal from an external terminal, the EN signal controlling the storage of the pixel data of the pixel driving circuit;
a gate driver configured to output gate information to the plurality of gate lines; and
a gate selection circuit configured to process the outputted gate information and control a point in time at which the pixel data is stored in the plurality of pixel driving circuits based on the received EN signals,
wherein the data selection circuit and the gate selection circuit are configured to simultaneously and selectively store the processed pixel data in the plurality of pixel driving circuits based on control of the received EN signals.

11. The display driving device according to claim 10, wherein the pixel driving circuit is configured to store the pixel data in the pixel driving circuit when the received EN signal is 'ON', and not to store the pixel data in the pixel driving circuit when the received EN signal is 'OFF'.

12. The display driving device according to claim 10, further comprising an EN signal control unit,
wherein the EN signal control unit is configured to divide an area of the pixel array, classify the divided area as a driving pixel array when the EN signal receiving unit receives an EN signal of 'ON', and
classify the divided area as a non-driving pixel array when the EN signal receiving unit receives an EN signal of 'OFF'.

13. The display driving device according to claim 10, wherein the data selection circuit and the gate selection circuit are configured to reduce the number of driven pixels to 1/N so as to simultaneously drive a pixel array having N pixel driving circuits among the pixel arrays having the plurality of pixel driving circuits.

14. The display driving device according to claim 11, wherein the output of the data driver is less than that of the pixel array.
